(19) United States
(12) Patent Application Publication
(10) Pub. No.: US 2005/0008420 A1
(43) Pub. Date: Jan. 13, 2005

(54) Applicator, and packaging and applicator device including applicator

(76) Inventor: Jean-Louis H. Gueret, Paris (FR)

Correspondence Address: Thomas L. Irving;FINNEGAN, HENDERSON, FARABOW,, GARRETT & DUNNER, L.L.P., 1300 I Street, N.W., Washington, DC, 20005-3315, US

(21) Appl. No.: 10/844,484

(22) Filed: May 13, 2004

Related U.S. Application Data
(60) Provisional application No. 60/475,775, filed on Jun. 5, 2003.

(30) Foreign Application Priority Data
May 14, 2003 (FR) 03 05763

(51) Int. Cl. B43K 5/16; B43K 7/12

(52) U.S. Cl. 401/129; 401/126

(57) ABSTRACT

The present invention provides an applicator (3) for applying a substance to a keratinous surface, the applicator comprising: a stem; an applicator member carried by the stem;
the applicator being characterized by the fact that the stem includes a deformable first portion (12) extending around the applicator member, said first portion (12) being arranged to be capable of deforming at least in part in response to deformation of the applicator member during application.

The present invention relates to devices for applying cosmetics, including care products, and more particularly but not exclusively to devices for applying nail varnish or eyeliner.

The flasks of nail varnish found on the market present a variety of content volumes, generally lying in the range 7 milliliters (ml) to 14 ml. The associated applicators comprise a stem with an applicator member at one end, in particular in the form of a paintbrush.

For flasks of relatively large capacity, e.g. 12 ml or more, the height of the flask body makes it possible to use a stem that is relatively long. In contrast, for flasks of small capacity, the height of the flask body is generally smaller and the stem must then be shorter if it is desired to ensure that the bristles of the brush remain long enough to avoid losing flexibility and quality of application. A short stem can be awkward to use and unattractive in appearance.

The length of the bristles of the brush cannot be shortened without making the brush stiffer and running the risk of forming streaks on the nail at the time of application.

There exists a need to benefit from an applicator enabling the substance to be applied appropriately, while still being pleasant in appearance, and which is simple to manufacture and to use, even when associated with a receptacle of small capacity, where necessary.

The invention seeks in particular to satisfy this need.

The invention achieves this by means of an applicator for applying a substance to a keratinous surface, the applicator comprising:
a stem;
an applicator member carried by the stem; the stem including a deformable first portion extending around the applicator member, said first portion being arranged to be capable of deforming at least in part in response to deformation of the applicator member during application.

By means of the invention, it is possible to benefit from an applicator member that is relatively flexible while giving the impression of having a stem of relatively long length, which is advantageous from the point of view of appearance.

Since the above-mentioned first portion is capable of deforming significantly in response to bending of the applicator member, the apparent length thereof can be smaller without losing flexibility, or comfort, or accuracy in application.

This first portion may be made in a distal part of the stem which may join a proximal part, which proximal part may optionally be substantially non-deformable during application.

When the applicator member is constituted by a paintbrush, the bristles may present an apparent length of 10 millimeters (mm) while providing the same performance and comfort in application as a conventional applicator in which the apparent length of the bristles is greater, e.g. 10% to 300% greater, e.g. equal to 17 mm.

Furthermore, the first portion may contribute to determining the way in which the applicator member deforms during application, such that the user can achieve greater accuracy, e.g. to follow the outline of the nails.

The distal part may be fitted to the proximal part, and in particular the distal and proximal parts may be assembled together by snap-fastening, by a force fit, by adhesive, or by heat-sealing.

The proximal and distal parts may be made of the same material, or they may be made at least in part out of two respective different materials.

The first portion, like the distal part, may be made at least in part out of an elastomer material.

The first portion may be made at least in part out of one of the following materials: silicone; ethylene-propylene diene monomer (EPDM); polyurethane (PU); styrene-isoprene-styrene (SIS); styrene-ethylene-butaline-styrene (SEBS); styrene-butadiene-styrene block copolymer (SBS); ethylene vinyl acetate copolymer (EVA); block polyether; and polyester; this list not being limiting.

The stem may include a second portion, the first and second portions together forming the stem, said second portion possibly being made at least in part out of one of the following materials: high density polyethylene (PEHD); low density polyethylene (PELD); PEBD, polypropylene (PP); polyacetal (POM); polyamide (PA); polyethylene terephthalate (PET); and polybutaline terephthalate (PBT); this list not being limiting.

The stem may include at least one slot extending over at least a fraction of the length of the first portion. Such a slot can make the first portion more deformable, and for example it can make it possible to use a material that is less flexible.

The first portion may extend around the applicator member in continuous or discontinuous manner, in particular it may surround the applicator member circumferentially either completely or in part.

The first portion may optionally be in contact with the applicator member.

The stem may include two opposite openings extending over at least a fraction of the length of the first portion, starting from its free end. These openings can improve the deformability of the first portion and/or can enable the applicator member to deform in a certain manner during application, in particular when the applicator member is in the form of a paintbrush.

The applicator member extends at least in part outside the first portion, and may for example extend optionally for the most part outside the first portion. The length of the part of the applicator member that is engaged inside the first portion may, for example, correspond to at least one-fourth or even at least one-third of the total length of the applicator member, particularly when the applicator member is a bundle of bristles.

The applicator member may be fixed to the proximal part or to the distal part.

The first portion may be more easily deformable in at least one preferred direction of deformation.

In the absence of application, the first portion may present an outside cross-section that is not constant, for example that is defined by a wall that tapers towards the free end of the stem. An inside or outside cross- section of the first portion may present a shape selected from the following: circular, non-circular, in particular oblong, oval, elliptical, polygonal, in particular square, rectangular, kidney-shaped, crenellated, star-shaped, and with one or more grooves, where appropriate.

The first portion may have a wall of thickness lying in the range 0.3 mm to 0.8 mm, for example. Regardless of its value, the thickness may be constant, or it may vary, in particular in the longitudinal direction, in particular it may decrease on approaching the free end of the first portion.

The length of the first portion may lie in the range 1 mm to 12 mm, for example, and in particular in the range 2 mm to 8 mm.

Over at least a fraction of its length, the stem may include at least one groove, and in particular two grooves situated opposite each other. At least one groove may extend over a major fraction of the length of the first portion of the stem, and in particular over substantially its entire length.

The apparent length of the applicator member may lie in the range 2 mm to 7 mm, for example, and in particular may be about 5 mm.

The applicator member may comprise at least one of the following elements: a bundle of bristles; a felt; a coating of flocking; and a foam. The applicator member may comprise a bundle of bristles forming a paintbrush of cross-section that may be flat or round. The applicator member may include at least one tip, optionally a flocked tip.

The applicator member may include bristles that are natural or synthetic, hollow or solid, with a capillary groove, of optionally polygonal section, of optionally circular section, or a mixture of bristles of different kinds and/or shapes.

At its end opposite from the distal part, the proximal part may join a handle member. The handle member may include means for fastening to a receptacle, in-particular a screw thread.

The invention also provides a device for packaging and applying a substance, in particular a cosmetic or a care product, on a keratinous surface, the device comprising:
an applicator as defined above; and
a receptacle containing the substance.

The applicator may be arranged to be capable of being removably fastened to the receptacle.

The receptacle may include a wiper.

The substance may be for application to the nails, in particular it may be a nail varnish.

The capacity of the receptacle may lie in the range 2 ml to 12 ml, and in particular in the range 5 ml to 9 ml, and may be about 7 ml.

The invention is not limited to a nail varnish applicator, and may apply in particular to an eyeliner applicator. In which case, the applicator member may be, for example, a paintbrush or something other than a paintbrush, in particular a felt tip, a tip of flocked plastics material, or indeed a foam tip. The presence of the deformable first portion can enable the sensation of hardness to be reduced during application to the eye.

The invention also provides a method of manufacturing an applicator for applying a substance to a keratinous surface, the method comprising the following steps:
providing a stem including a sliding sleeve, the sleeve being in a waiting position allowing access to one end of the stem;
securing an applicator member to the end of the stem; and
causing the sleeve to slide along the stem towards the end thereof in such a manner as to cause the sleeve to cover the applicator member, at least in part.

At least a fraction of the sleeve may be arranged so as to be capable of deforming at least in part in response to deformation of the applicator member during application.

The sleeve may be arranged to be held in position on the stem by snap-fastening or by friction at the end of its sliding towards the end of the stem.

The invention can be better understood on reading the following detailed description of non-limiting embodiments thereof, and on examining the accompanying drawings, in which:

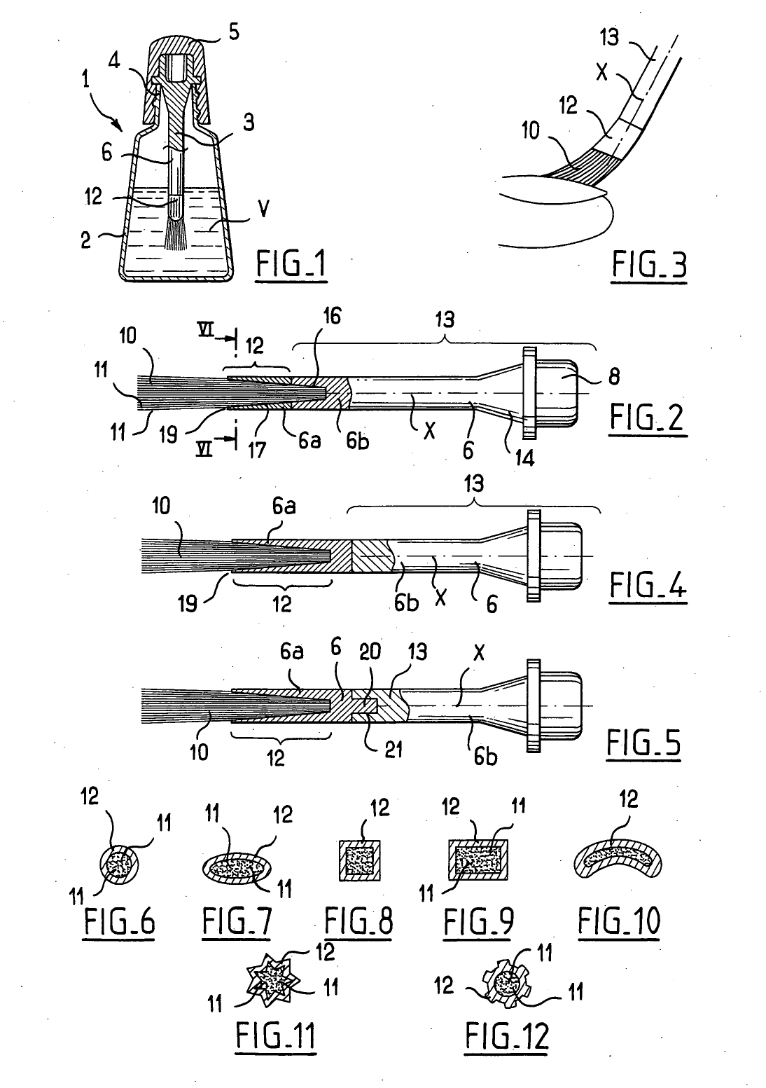

FIG. 1 is a diagrammatic and fragmentary longitudinal section view of an embodiment of a packaging and applicator device made in accordance with the invention;

FIG. 2 is a diagrammatic and fragmentary axial section view showing in isolation the stem of the FIG. 1 applicator;

FIG. 3 shows deformation of the first portion of the stem during application;

FIGS. 4 and 5 are views analogous to FIG. 2, showing various embodiments of the applicator;

FIG. 6 is a cross-section on VI-VI of FIG. 2;

FIGS. 7 to 12 are views analogous to FIG. 6, showing variant embodiments of the applicator;

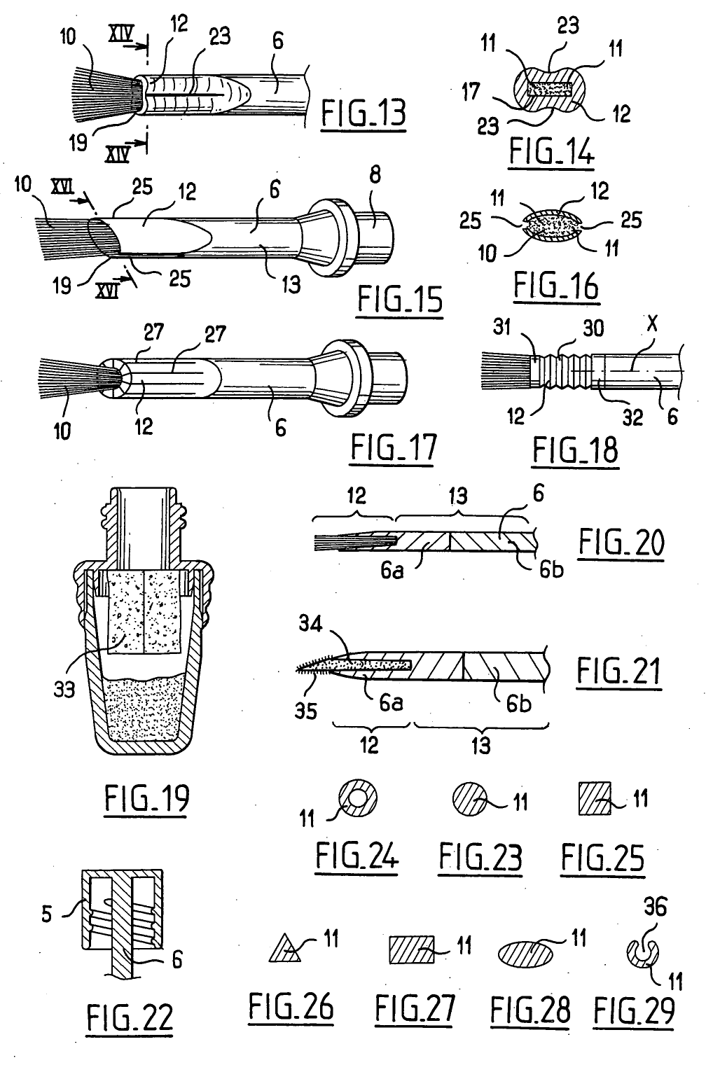

FIG. 13 shows that it is possible to make the stem with at least one longitudinal groove;

FIG. 14 is a cross-section on XIV-XIV of FIG. 13;

FIG. 15 is a fragmentary diagrammatic perspective view of an applicator constituting another variant embodiment;

FIG. 16 is a cross-section on XVI-XVI of FIG. 15;

FIG. 17 is a view analogous to FIG. 15 showing a variant embodiment of the invention;

FIG. 18 is a fragmentary side view of a stem including a bellows-shaped portion;

FIG. 19 is a diagrammatic axial section view showing in isolation a receptacle provided with a wiper member;

FIGS. 20 and 21 are diagrammatic and fragmentary views in longitudinal section of examples of applicators for applying substance to the eyelids;

FIG. 22 shows that it is possible to make the stem integrally with the handle member;

FIGS. 23 to 29 show various examples amongst others of cross-sections for bristles;

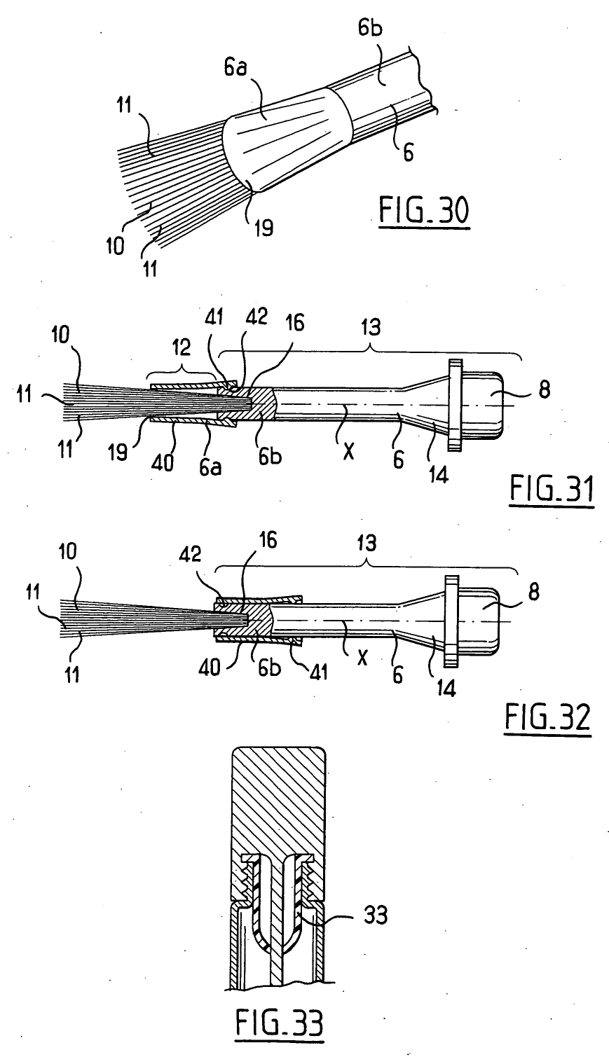

FIG. 30 is a diagrammatic and fragmentary view of an applicator constituting another variant embodiment;

FIGS. 31 and 32 are diagrammatic and fragmentary axial section views showing a variant embodiment of the invention; and

FIG. 33 is a diagrammatic and fragmentary longitudinal section showing a variant embodiment of the wiper member.

The packaging and applicator device 1 shown in FIG. 1 comprises a receptacle 2 and an applicator 3 releasably fastened to the receptacle 2.

In the example described, the top of the receptacle 2 includes a neck 4 with an outside thread onto which it is possible to screw a closure cap 5 which also serves as a handle member for the applicator 3.

The receptacle 2 contains nail varnish V in the example described, but it would not go beyond the ambit of the present invention for the receptacle to contain some other substance.

The applicator 3 comprises a stem 6 shown in isolation in FIG. 2 and carrying at one end an endpiece 8 enabling it to be fastened in the closure cap 5, and at its opposite end a bundle 10 of bristles 11 serving to constitute a paintbrush.

More particularly, in the example described, the stem 6 comprises a distal part 6a and a proximal part 6b made of different materials, the proximal part 6b itself comprising a circularly cylindrical part about an axis X, said cylindrical part being connected to the endpiece 8 via a flaring part 14.

The end of the proximal part 6b adjacent to the distal part 6a includes a housing 16 having the bundle 10 of bristles fixed to the end thereof, e.g. by stapling, the bundle being folded in two for example and fixed halfway along its length by a staple which is put into place in the end of the housing 16.

The distal part 6a defines a housing 17 about the axis X and that is open at both axial ends, with the bundle 10 passing therethrough.

The first portion 12 is defined by the portion of the stem 6 which extends around the applicator member 10 and which can deform at least in part in response to deformation of the applicator member during application. In the example shown, the first portion 12 extends over the entire length of the distal part 6a. The remainder of the stem defines the second portion 13.

This second portion 13 may be entirely non-deformable or it may be non-deformable in part only.

In the example described, the wall of the first portion 12 tapers towards the free end 19 of the stem 6, and the first portion 12 presents inside and outside cross-sections that are both circular, as can be seen in FIG. 6. Sections of other shapes are also possible, as described below.

In the example described, the distal part 6a is made of a plastics material that is more flexible than the material from which the proximal part 6b is made. By way of example, the distal part 6a is made of an elastomer, which may be overmolded to the end of the distal part 6b, and in particular it may be made of a thermoplastic elastomer.

In use, as shown in FIG. 3, the bundle 10 can flex in contact with the surface onto which the substance is to be applied, e.g. a nail, and the first portion 12 can accompany the deformation of the bundle 10 to some extent because of its own deformability, whereas the second portion 13 presents a shape that is substantially unchanged.

The first portion 12 thus contributes to comfort during application and makes it possible for the apparent length of the stem 6 outside the closure cap 5 when the applicator is seen from the side to be long enough to be pleasing, esthetically speaking. This apparent length also makes it easier to apply the substance accurately by ensuring that during application the closure cap does not impede observation of the surface onto which the substance is to be applied.

The first portion 12 also enables the bundle 10 to behave as though it is longer that it appears to be because the first portion 12 can, to some extent, accompany the deformation of the fraction of the bundle 10 which extends inside the housing 17.

The first portion 12 may deform in bending, i.e. deforming so that its longitudinal axis becomes curvilinear instead of coinciding with the axis X. The first portion 12 may also deform by changing section, in particular by taking up a flatter section, thereby encouraging the bristles of the bundle 10 to spread out, in particular into a fan shape.

Once application has finished, the first portion 12 can return to its initial shape by shape memory, because of its own elasticity, and in particular its longitudinal axis can again become rectilinear and coincide with the axis X.

Various modifications may be applied to the applicator without going beyond the ambit of the present invention.

For example, the bundle 10 may be implanted entirely in the distal part 6a, as shown in FIG. 4. In this example, the first portion 12 extends over only a fraction of the length of the distal part 6a which is made entirely out of elastomer material.

The second portion 13 then extends at least in part over the distal part 6a which is made of elastomer.

The distal and proximal parts, when they are made out of different materials, may be assembled together in various ways other than by overmolding material, and in particular they may be assembled together by complementary shapes as shown in FIG. 5, e.g. by making a male shape 20 at one end of the distal part 6a and configured to engage in a housing 21 of complementary shape in the proximal part 6b.

In the example of FIG. 2, the first portion 12 has a wall of circular cross-section surrounding the bundle 10. When application is not taking place, this wall may present, in a variant, a cross-section that is not circular, for example it may be substantially oval as shown in FIG. 7.

The first portion 12 may also present a cross-section of polygonal shape, e.g. square or rectangular as shown in FIGS. 8 and 9, kidney-shaped as shown in FIG. 10, star-shaped as shown in FIG. 11, or crenellated, as shown in FIG. 12.

By way of example, the stem 6 may be made to have a longitudinal groove 23 which may extend over all or part of the length of the stem, and in particular over a fraction of the length thereof starting from its free end 19. In particular, the groove 23 may extend only over the second portion 12, e.g. over a major fraction thereof, or over at least some of the distal part 6a.

In FIG. 14, it can be seen that the stem 6, and in particular its first portion 12, can present inside and outside cross-sections that are not of the same shape.

More precisely, the stem 6 may be made in particular over a fraction of its length starting from its free end 19 to have an outside cross-section that is generally oblong in shape with two opposite grooves 23, as can be seen in FIG. 14. The inside cross-section may be rectangular, for example, such that the wall of the first portion 12 presents variations in thickness around the housing 17 through which the bundle 10 of bristles passes.

The grooves 23 may be used for channeling substance running along the stem 6 after the applicator has been withdrawn from the receptacle so that the substance flows towards the free end 19 into one or more predefined zones of the bundle 10, and in particular into a central region thereof, thereby improving comfort of application, and in particular accuracy in applying makeup.

FIGS. 15 and 16 show that it is possible for the stem 6 to have two diametrically opposite side openings 25 extending from its free end 19, which openings extend, for example, over a major fraction of the first portion 12. These openings 25 can enable the bristles 11 of the bundle 10 to spread out in a fan shape during application by passing through the openings 25.

The shape of the cross-section of the first portion 12 may define at least one preferred direction in which the first portion 12 can deform. For example, a cross-section of oblong shape can bend more easily about an axis which is parallel to-a major axis of the oblong section.

A kidney-shaped cross-section may give the bundle 10 a gutter shape that enables it to fit more easily around the convex shape of a nail.

The stem 6 may be made with at least one slot for improving the deformability of at least a fraction of the length of the stem, and in particular the deformability of its first portion 12.

FIG. 17 shows a stem 6 comprising a plurality of longitudinal slots 27 with touching edges, which slots are distributed uniformly around the circumference of the first portion 12 and pass through the entire thickness of its wall in the example described. In a variant, the slots 27 could extend over only a fraction of the thickness of the wall, in particular starting from its outside surface. They could also have edges that do not touch one another.

As can be seen in FIG. 18, the stem 6 can be made with at least one bellows-shaped portion 30 extending between regions 31 and 32 and capable, for example, of bending about at least one axis perpendicular to the longitudinal axis X.

The distal part 6a of the stem 6 may also be given a duck-bill shape, as shown diagrammatically in FIG. 30. The end of the distal part 6a which joins the proximal part 6b of the stem 6 is substantially circular in shape and the free end 19 of the distal part 6a is of a flattened shape.

In the variant embodiment shown in FIG. 31, the stem 6 presents a distal part 6a constituted by a sleeve 40 suitable for sliding along the proximal part 6b of the stem.

FIG. 32 shows the sleeve 40 in a waiting position on the proximal part 6b of the stem 6, allowing easy access to the housing 16 for fastening the bundle 10 of bristles 11 therein.

Once the bundle 10 of bristles 11 has been put into place, the sleeve 40 is moved relative to the proximal part 6b of the stem so as to surround a fraction of the bundle 10. The sleeve 40 is held in its final position on the proximal part 6b of the stem 6 by snap-fastening, for example, having an annular bead 41 that engages in an annular groove 42 formed in the end of the proximal part 6b of the stem 6.

In the examples of FIGS. 15, 17, and 18, in particular, the deformability of the first portion 12 can be obtained by virtue of the presence of the openings 25, the slots 27, or the bellows 30, and the first portion 12 may present sufficient deformability without it being necessary to make it out of an elastomer material, the first portion 12 possibly being made, where appropriate, out of the same material as the remainder of the stem. Nevertheless, in order to benefit from even greater deformability, it is preferable to make the first portion 12 at least in part out of an elastomer material.

The invention is applicable not only to the field of applying nail varnish, but more general to the field of applying makeup, and for example to applying a substance to the eyelids, in particular to applying an eyeliner.

This substance may be contained, for example, in a receptacle that is provided with a wiper member 33 as shown in FIGS. 19 and 33, serving to wipe the applicator member as it leaves the receptacle.

The wiper member 33 may be made of pierced foam, as shown in FIG. 19, or out of an elastomer sleeve, as shown in FIG. 33.

When used with an eyeliner, the applicator member may be constituted by a paintbrush as shown in FIG. 20 or by any other applicator member, e.g. a felt tip 34, made of foam or of other material, e.g. a solid plastics material, possibly an elastomer. The applicator member may comprise a flocked tip 35, as shown in FIG. 21.

The applicator may be made in still other ways, and in particular the stem 6 may be made integrally with the closure cap 5, as shown in FIG. 22.

When the applicator member comprises a bundle 10 of bristles 11, the bristles may present a variety of cross-sections, for example one of the sections shown in FIGS. 24 to 29.

Specifically, the bristles 11 may be solid as shown in FIG. 23, hollow as shown in FIG. 24, polygonal in section as shown in FIGS. 25 to 27, and in particular square, triangular, or rectangular, or they may be oval as shown in FIG. 28, possibly also including at least one capillary groove 36, as shown in FIG. 29.

The bristles may be made of natural or synthetic materials. It is possible to use a mixture of bristles of different shapes and/or made of different materials.

The stem may include at least one rigid portion.

Throughout the description, including in the claims, the term “comprising a” should be understood as being synonymous with “comprising at least one”, unless specified to the contrary.

1. An applicator (3) for applying a substance to a keratinous surface, the applicator comprising:
a stem (6); and
an applicator member (10) carried by the stem (6);
the applicator being characterized by the fact that the stem (6) includes a deformable first portion (12) extending around the applicator member (10), said first portion (12) being arranged to be capable of deforming at least in part in response to deformation of the applicator member (10) during application.

2. An applicator according to claim 1, characterized by the fact that the first portion (12) is made in a distal part (6a) of the stem which joins to a proximal part (6b).

3. An applicator according to claim 2, characterized by the fact that the proximal part (6b) is substantially not deformable during application.

4. An applicator according to any preceding claim, characterized by the fact that the first portion (12) is formed in a distal part (6a) of the stem which is overmolded onto an adjacent proximal part (6b) of the stem.

5. An applicator according to any one of claims 1 to 3, characterized by the fact that the first portion (12) is formed in a distal part (6a) which is fitted to an adjacent proximal part (6b) of the stem, the distal and proximal parts (6a, 6b) being assembled together in particular by snap-fastening, by a force fit, by adhesive, or by heat-sealing.

6. An applicator according to claim 2 or claim 3, characterized by the fact that the proximal and distal parts (6b, 6a) are made of the same material.

7. An applicator according to claim 2 or claim 3, characterized by the fact that the proximal and distal parts (6b, 6a) are made at least in part out of two respective different materials.

8. An applicator according to any preceding claim, characterized by the fact that the first portion (12) is made at least in part out of an elastomer material.

9. An applicator according to any one of claims 1 to 7, characterized by the fact that the first portion (12) is made at least in part out of one of the following materials: silicone; EPDM; PU; SIS; SEBS; SBS; EVA; block polyether; and polyester.

10. An applicator according to claim 2 or claim 3, characterized by the fact that the stem (6) includes a second portion (13) made at least in part out of one of the following materials: PEHD; PELD; PP; POM; PA; PET; and PBT.

11. An applicator according to any preceding claim, characterized by the fact that the stem (6) includes at least one slot (27) extending over at least a fraction of the length of the first portion (12).

12. An applicator according to any preceding claim, characterized by the fact that the first portion (12) extends around the applicator member (10) in continuous manner.

13. An applicator according to any one of claims 1 to 11, characterized by the fact that the first portion (12) extends around the applicator member (10) in discontinuous manner.

14. An applicator according to the preceding claim, characterized by the fact that the first portion (12) includes two opposite openings (25).

15. An applicator according to claim 2 or claim 3, characterized by the fact that the applicator member (10) is fastened to the proximal part (6b).

16. An applicator according to claim 2 or claim 3, characterized by the fact that the applicator member (10) is fixed to the distal part (6a).

17. An applicator according to any preceding claim, characterized by the fact that the first portion (12) is more easily deformable in at least one preferred direction of deformation.

18. An applicator according to any preceding claim, characterized by the fact that the first portion (12), in the absence of application, presents an outside cross-section that is not constant.

19. An applicator according to any preceding claim, characterized by the fact that at least one inside or outside cross-section of the first portion (12) of the stem (6) presents a shape selected from amongst the following shapes: circular, non-circular, in particular oblong, oval, elliptical, polygonal, in particular square, rectangular, kidney-shaped, crenellated, star-shaped, and with one or more grooves.

20. An applicator according to any preceding claim, characterized by the fact that the first portion (12) comprises a wall surrounding at least part of the applicator member (10) and of thickness lying in the range 0.3 mm to 0.8 mm.

21. An applicator according to any one of claims 1 to 20, characterized by the fact that the first portion (12) comprises a wall surrounding at least part of the applicator element and of thickness that varies, in particular in the longitudinal direction, in particular decreasing on coming closer to the free end (19) of the first portion.

22. An applicator according to any preceding claim, characterized by the fact that the length of the first portion (12) of the stem (6) lies in the range 1 mm to 12 mm, and in particular in the range 2 mm to 8 mm.

23. An applicator according to any preceding claim, characterized by the fact that the stem (6) includes, over at least a fraction of its length, at least one groove (23), and in particular two grooves (23) situated opposite each other.

24. An applicator according to the preceding claim, characterized by the fact that at least one groove (23) extends over a major fraction of the length of the first portion (12) of the stem (6), and in particular over substantially its entire length.

25. An applicator according to any preceding claim, characterized by the fact that the apparent length of the applicator member (10) lies in the range 2 mm to 7 mm, and in particular is of the order of about 5 mm.

26. An applicator according to any preceding claim, characterized by the fact that the applicator member (10) comprises at least one of the following elements: a bundle (10) of bristles (11); a felt; a coating of flocking; a foam.

27. An applicator according to any preceding claim, characterized by the fact that the applicator member (10) comprises a bundle of bristles (11) forming a paintbrush.

28. An applicator according to any one of claims 1 to 26, characterized by the fact that the applicator member (10) comprises at least one flocked tip (35).

29. An applicator according to claim 2 or claim 3, characterized by the fact that the proximal part (6b) is joined to a handle member (5) at an end opposite from the distal part (6a).

30. An applicator according to the preceding claim, characterized by the fact that the handle member (5) includes means for fastening it to a receptacle, in particular a screw thread.

31. A packaging and applicator device for applying a substance, in particular a cosmetic or a care product, on a keratinous surface, the device being characterized by the fact that it comprises:
an applicator (3) according to any preceding claim; and
a receptacle (2) containing the substance (V).

32. A device according to the preceding claim, characterized by the fact that the applicator (3) is arranged in such a manner as to be capable of being releasably fastened to the receptacle (2).

33. A device according to the preceding claim, characterized by the fact that the receptacle (2) includes a wiper (33).

34. A device according to claim 31, characterized by the fact that the substance (V) is a substance for application to the nails, in particular a nail varnish.

35. A device according to claim 31, characterized by the fact that the substance is an eyeliner.

36. A device according to any one of claims 31 to 35, characterized by the fact that the capacity of the receptacle (2) lies in the range 2 ml to 12 ml, and in particular in the range 5 ml to 9 ml, or indeed about 7 ml.

37. A method of manufacturing an applicator as defined in claim 1 for applying a substance to a keratinous surface, the method being characterized by the fact that it comprises the following steps:
providing a stem (6) including a sliding sleeve (40), the sleeve (40) being in a waiting position allowing access to one end of the stem (6);
securing an applicator member (10) to the end of the stem (6); and
causing the sleeve (40) to slide along the stem (6) towards its end in such a manner as to cause the sleeve to cover the applicator member (10) at least in part.

38. A method according to the preceding claim, characterized by the fact that the sleeve (40) is arranged to be held in place on the stem (6) by snap-fastening or by friction at the end of its sliding towards the end of the stem (6).
